(19) United States
(12) Patent Application Publication
(10) Pub. No.: US 2009/0232277 A1
(43) Pub. Date: Sep. 17, 2009

(54) SYSTEM AND METHOD FOR INSPECTION OF ITEMS OF INTEREST IN OBJECTS

(75) Inventors: Forrest Frank Hopkins, Cohoes, NY (US); Clifford Bueno, Clifton Park, NY (US); Yanfeng Du, Rexford, NY (US); Joseph Bendahan, San Jose, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/178,128

(22) Filed: Jul. 23, 2008

Related U.S. Application Data
(60) Provisional application No. 61/036,502, filed on Mar. 14, 2008.

(51) Int. Cl. G01N 23/04

(52) U.S. Cl. 378/57; 378/62

(57) ABSTRACT

An inspection system is provided. The inspection system includes at least one radiation source including single or multiple energies and configured to transmit a radiation beam through an object under inspection. The inspection system further includes an array of detectors configured to receive multiple radiation beams transmitted through the object, wherein the array of detectors are oriented at different angles with respect to the radiation beam and wherein at least one of the radiation source, and the array of detectors or the object is configured to be actuated in a translational direction relative to each other. The inspection system further includes processing circuitry coupled to the array of detectors and configured to generate a three dimensional image of the object.

### CROSS REFERENCE TO RELATED APPLICATIONS

This application claims the benefit of U.S. Provisional Application No. 61/036502 filed on Mar. 14, 2008, which is incorporated herein in its entirety by reference.

### BACKGROUND

The invention relates generally to inspection systems including security and non-destructive testing applications, and more particularly to inspection systems for detecting items of interest.

Some luggage inspection systems commonly use simple X-ray imaging systems that are completely dependent on interpretation by an operator. More sophisticated systems use dual-view, multi-view arrangements and computed tomography (CT) that can automatically recognize certain types of threats and/or contraband. Single or dual-view systems usually scan baggage as it moves on a conveyor using a fan beam of X-rays in a fixed geometry. CT systems typically employ an x-ray source and detectors rotating around the luggage and are limited in throughput.

Typically, cargo inspection systems employ one or two views and require operators to review the images for items of interest such as drugs, explosives, nuclear and shielding materials. Some systems employ dual-energy x-ray sources to reduce the dependence to operators and/or to reduce the false alarm rate. However, the features employed for detection contain the superposition of materials along the path length.

Accordingly, there is a need for a high speed X-ray inspection device that can help the operators to analyze images in an expedited way and/or to automatically detect items of interest with low false alarm rates.

### BRIEF DESCRIPTION

In accordance with an embodiment of the invention, an inspection system is provided. The inspection system includes at least one radiation source including single or multiple energies, wherein the radiation source is configured to transmit a radiation beam on an object having one or more items of interest under inspection. The inspection system also includes an array of detectors configured to receive multiple radiation beams transmitted through the object, wherein the array of detectors are oriented at different angles with respect to the radiation beam from the radiation source, and at least one of the radiation source and the array of detectors or the object is configured to be actuated in a translational direction relative to the other. The inspection system further includes processing circuitry coupled to the array of detectors and is configured to generate a three dimensional image of the object.

In accordance with another embodiment of the invention, a method for manufacturing an inspection system is provided. The method includes providing at least one radiation source including single or multiple energies, wherein the at least one radiation source is configured to transmit a radiation beam on an object. The method further includes providing an array of detectors configured to receive multiple radiation beams transmitted through the object, wherein the array of detectors is oriented at different angles with respect to the radiation beam from the at least one radiation source and at least one of the radiation source and the array of detectors or the object is configured to be actuated in a translational direction relative to the other. The method also includes providing processing circuitry coupled to the array of detectors and configured to generate a three dimensional image of the object.

These and other advantages and features will be more readily understood from the following detailed description of preferred embodiments of the invention that is provided in connection with the accompanying drawings.

### DRAWINGS

FIG. 1 is a diagrammatic illustration of an inspection system in accordance with an embodiment of the invention.

FIG. 2 is a top view of the inspection system in FIG. 1.

FIG. 3 is a schematic illustration of exemplary radiograms obtained employing a ratio based technique to the images generated by security inspection system in FIG. 1.

FIG. 4 is a schematic illustration of one slice from an exemplary limited angle computed tomography image dataset that was produced by backprojection of a complete set of projections generated as an object was translated through a field-of-view.

FIG. 5 is a diagrammatic illustration of a vertical slice through the image data set in FIG. 4.

FIG. 6 is a flow chart representing steps in a method for manufacturing an inspection system in accordance with an embodiment of the invention.

### DETAILED DESCRIPTION

As discussed in detail below, embodiments of the invention include a system and method for inspection of threat material in objects. As used herein, the term ‘objects’ refers to luggage, parcels, and the like. The system and method disclosed herein, include additional angular sampling to generate a three-dimensional image that distinguishes objects of threat material based upon density and atomic number information. Non-limiting applications of the technique may be in cargo inspection systems and airport baggage inspection systems.

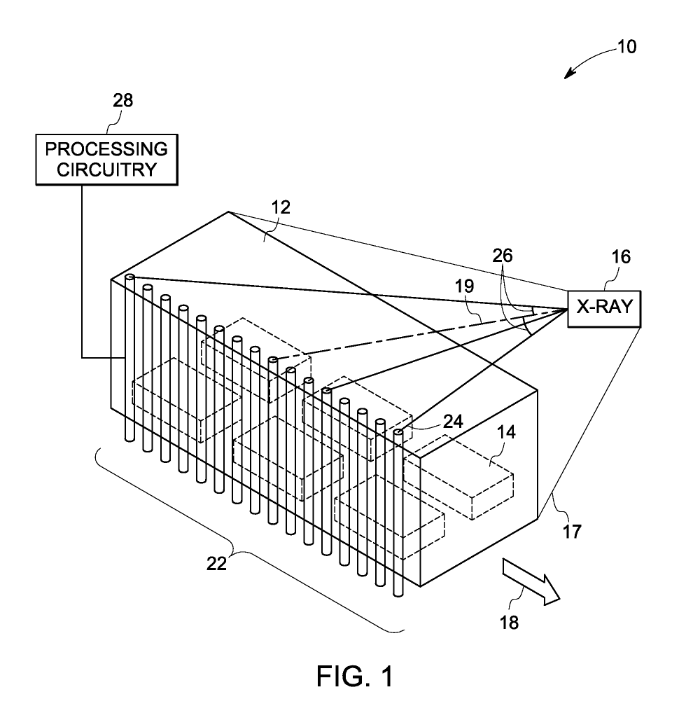

FIG. 1 is a diagrammatic illustration of an inspection system 10. The inspection system 10 inspects the object 12. In the illustrated embodiment, the object 12 is a container including one or more items of interest 14. At least one radiation source 16 including single or multiple energies transmits a radiation beam 17 on the object 12. In a particular embodiment, the radiation source 16 includes an X-ray source, gamma ray emitting radioactive source or a neutron source. In another embodiment, the source 16 includes dual energy between about 9 MeV and about 4.5 MeV. The radiation source 16 is also configured to actuate in a translational direction 18 relative to the object 12. In an exemplary embodiment, the radiation source 16 and the array of detectors 22 actuates in a translational direction relative to the object 12. In an alternative embodiment, the radiation source 16 is stationary and the object 12 actuates in a translational direction relative to the radiation source and the array of detectors 16.

An array of detectors 22 receives multiple radiation beams 24 transmitted through the objects 14. The array of detectors 22 is oriented at different angles 26 with respect to a radiation beam axis 19 from the source 16. The angular sampling enables the system 10 to capture the radiation beams 24 transmitted through the object 12. In the illustrated embodiment, the array of detectors 22 includes multiple linear arrays of detectors. In another embodiment, the array of detectors 22 includes a flat panel array or continuously pixilated array of detectors that may provide a desirable angular sampling. In yet another embodiment, the array of detectors 22 detects special nuclear material or shielding material.

Processing circuitry 28 is further coupled to the array of detectors 22 to generate a three dimensional image of the object 12 and the one or more objects 14 based upon the radiation beams 24. The processing circuitry 28 calculates an attenuation coefficient of the objects 14 and further determines multiple parameters representing a composition and volume of the one or more items of interest based upon the attenuation coefficient. Non-limiting examples of the parameters include atomic number, size and shape of the one or more items of interest 14. In a particular embodiment, an output of the system 10 is about 15 seconds per unit length of the object. The system 10 may also include a display monitor coupled to the processing circuitry 28 to display the three dimensional image of the object 12 and the one or more items of interest 14.

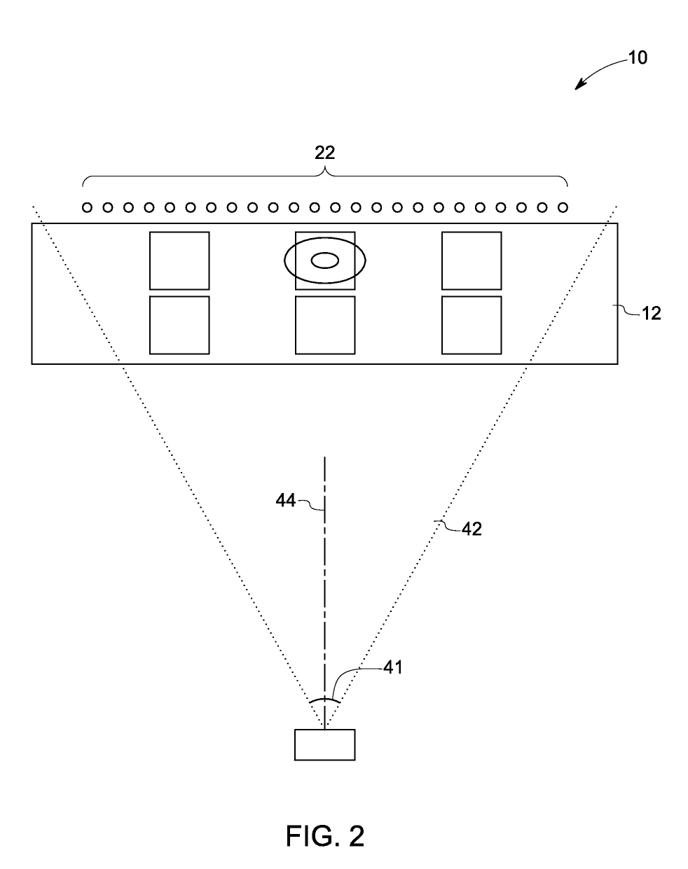

FIG. 2 is a top view of the system 10 in FIG. 1 with a 45 degree in-plane angular sampling referenced by numeral 41 relative to the beam axis 19 of the source 16. Furthermore, in the illustrated embodiment, spacing between the detectors is about 10 cm. It should be appreciated that the system 10 may also include other angles of sampling and other spacing measurements. The radiation emitted from the X-ray source 16 is a cone 42 with the beam axis 19. In the illustrated embodiment, the array of detectors 22 are distributed over 45 degrees (±22.5 degrees with respect to the beam axis 19) providing a sampling granularity of about 1.45 degrees. In another embodiment, each of the arrays of detectors 22 may contain several individual scintillation detectors, each with a cross-sectional area of about 3 mm². Projection data is obtained during a stepwise progression of object 12 or the fixed combination of the X-ray source 16 and detector 22, relative to each other resulting in the cone-beam 42 data set for reconstruction process. One plane of image reconstruction is in a plane perpendicular to the beam axis 19. In a particular embodiment, the scanning parameters included two different step sizes of the object 12 longitudinally through the fixed cone-beam inspection system 10. In a non-limiting example, a step size is 1 cm, resulting in 2000 individual sets of measurements to cover an entire length of 10 m of the object. The reconstruction process may be performed by a standard filtered backprojection (FBP) or a direct backprojection (DBP). The DBP corresponds to a first step in an iterative reconstruction sequence. The details of the reconstruction process are well known in the art and hence not described in detail herein.

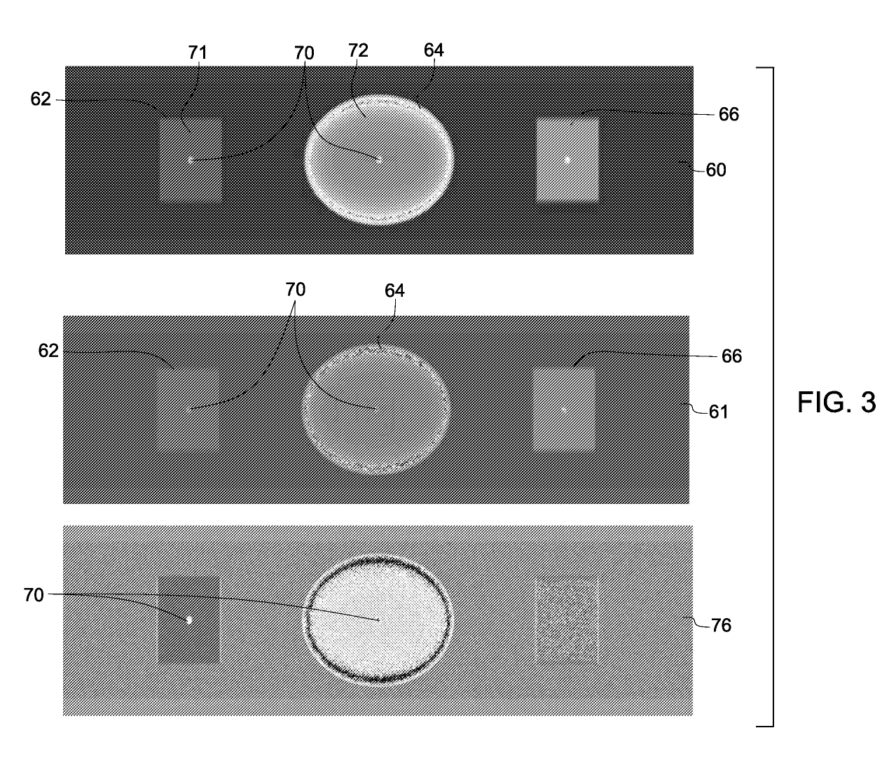

FIG. 3 is a schematic illustration of a series of two dimensional images 60, 61 obtained by the system 10 for X-ray source voltages of 9 MV and 4.5 MV, respectively. The radiograms 60 and 61 were generated based upon inspection of three sample objects. Image 62 corresponds to radiation attenuated by a sphere of uranium disposed within a paper-like material. Similarly, image 64 corresponds to radiation attenuated by the sphere of uranium embedded within an ellipsoidal shaped steel. Further, image 66 corresponds to radiation attenuated by the sphere of uranium embedded within a block of concrete. The intensity of attenuated radiation is compared to intensity of the radiation without the object to compute parameters such as, but not limited to, an opacity or density of the object. As illustrated, region 70 represents radiation attenuated by uranium. Further, regions 71 represent objects with lesser opacity, while regions 72 represent objects with higher opacity. Accordingly, a higher amount of radiation was attenuated along a path penetrating the object. A ratio of the radiograms 60 and 61 was computed to generate radiogram 76. The ratio approach, also referred to as an energy discrimination technique, is employed to reveal higher sensitivity to different atomic numbers of materials and enables desirable differentiation between materials based upon chemical composition in an object. In an exemplary embodiment, materials having a lower atomic number are differentiated from materials having a higher atomic number. Other, more quantitative dual energy techniques are available to produce estimations specifically of average atomic number of materials or actual amounts of particular materials.

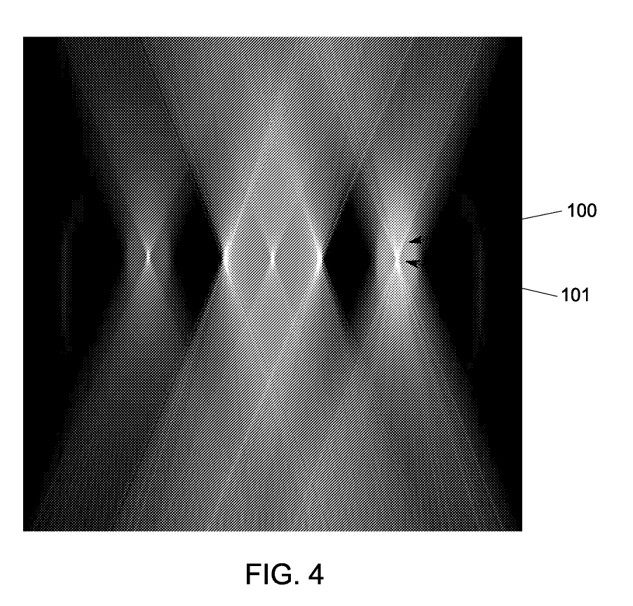

FIG. 4 is a schematic illustration of one slice from the limited angle CT image dataset that was produced by backprojection of a complete set of projections generated as the object was translated through the field-of-view. The figure is a single transverse CT slice as viewed from the top of the system. The distortion of the objects, due to the lack of complete angular sampling as is done in complete CT examinations, is evident in the figure. The feature 100 is the distorted image of the concrete block and feature 101 is the uranium sphere.

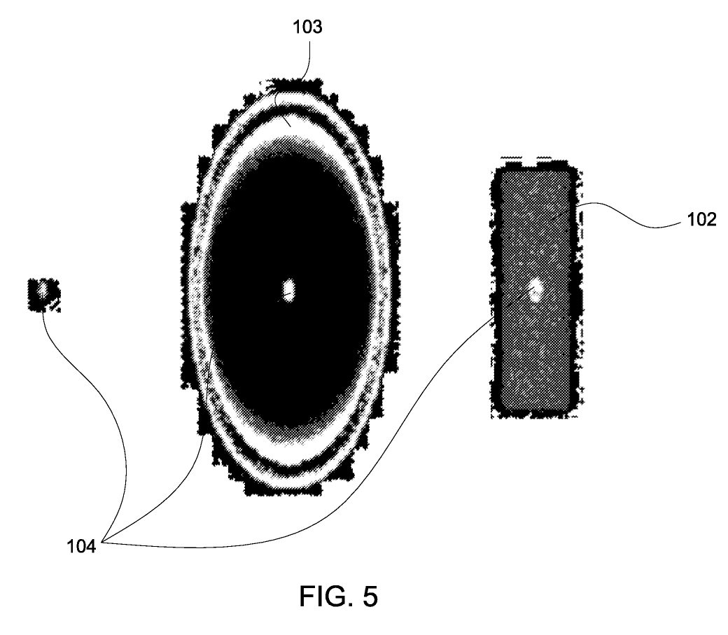

FIG. 5 is an illustration of a vertical slice through the 3D image data set from FIG. 4, produced at the depth of the uranium spheres. This limited angle CT image data set is sometimes referred to as a laminography image data set. Materials 102 and 103 are the concrete block and steel oval, respectively. The features 104 are the three uranium spheres.

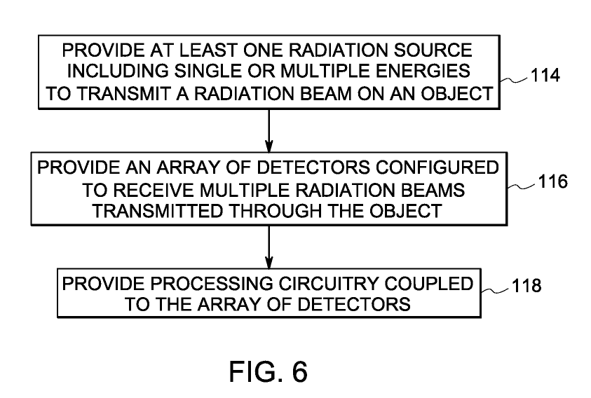

FIG. 6 is a flow chart representing steps in a method for manufacturing a security inspection system. The method includes providing at least one radiation source having single or multiple energies in step 114. In one embodiment, the radiation source and the array of detectors are translated relative to the object that is stationary. The radiation source transmits a radiation beam on an object under inspection. An array of detectors is provided in step 116. The array of detectors is configured to receive multiple radiation beams transmitted through the object. Further, the array of detectors is oriented at different angles with respect to the radiation beam from the at least one radiation source. Further, at least one of the radiation source and the array of detectors or the object is configured to be actuated in a translational direction relative to the other. In an exemplary embodiment, a linear array of detectors is provided. In another embodiment, a pixilated array of detectors is provided. Processing circuitry is coupled to the array of detectors in step 118 and configured to generate a three dimensional image of the object and the objects. The processing circuitry is also configured to receive multiple radiation beams received by the array of detectors. Furthermore, the processing circuitry calculates an attenuation coefficient of the one or more objects within the object based upon transmitted radiation beams. Additionally, multiple parameters representing a composition and volume of the one or more items of interest are determined based upon the attenuation coefficient. In a non-limiting example, an atomic number, a size, or a shape is determined. A display monitor coupled to the processing circuitry is provided to display the three dimensional image of the object and the one or more items of interest.

The various embodiments of a system and method for inspection of items of interest in objects as described above thus provide a convenient and efficient means to prevent security incidents from occurring. Three dimensional imaging and angular sampling provide increased detection capability for items of interest such as, but not limited to, special nuclear materials, and explosives. The system and technique described above facilitate in a simple translation geometry which tracks the normal flow of objects most efficiently through an inspection system, reduction of false alarms, consequently reducing expensive and time consuming secondary inspections of objects.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a pixilated array of detectors described with respect to one embodiment can be adapted for use in inspection of a check-in luggage. Similarly, the various features described, as well as other known equivalents for each feature, can be mixed and matched by one of ordinary skill in this art to construct additional systems and techniques in accordance with principles of this disclosure.

At least one embodiment of the present invention is described below in reference to its application in connection with and operation of a system for inspecting cargo crates, pallets, and/or objects. However, it should be apparent to those skilled in the art and guided by the teachings herein provided that the invention is likewise applicable to any suitable system for scanning objects including, without limitation, boxes, drums, and luggage, transported by water, land, and/or air, as well as other objects. Further, although embodiments of the present invention are described below in reference to its application in connection with and operation of a system incorporating an X-ray scanning system for inspecting cargo crates, pallets, and/or objects, it should apparent to those skilled in the art and guided by the teachings herein provided that any suitable radiation source including, without limitation, neutrons or gamma rays or combination, may be used in alternative embodiments.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. An inspection system comprising:
at least one radiation source comprising single or multiple energies, the at least one radiation source configured to transmit a radiation beam on an object comprising one or more items of interest under inspection;
an array of detectors configured to receive a plurality of radiation beams transmitted through the object, the array of detectors configured to be oriented at different angles with respect to the radiation beam from the radiation source, and at least one of the radiation source and the array of detectors or the object is configured to be actuated in a translational direction relative to the other; and
processing circuitry coupled to the array of detectors and configured to generate a three dimensional image of the object.

2. The system of claim 1, further comprising a display monitor configured to display the three dimensional image of the object and the one or more objects.

3. The system of claim 1, wherein the processing circuitry is configured to:
receive signals from the array of detectors as a response from a plurality of radiation beams;
calculate attenuation coefficient of the one or more items of interest within the object based upon transmitted radiation beams; and
determine a plurality of parameters of the one or more items of interest based upon the attenuation coefficient.

4. The system of claim 3, wherein said parameters comprise at least one of atomic number, size, and shape of the at least one item of interest.

5. The system of claim 1, wherein the object comprise luggage, or a parcel.

6. The system of claim 1, wherein the array of detectors comprises a linear array of detectors.

7. The system of claim 1, wherein the array of detectors comprises a flat panel array or continuously pixilated array of detectors.

8. The system of claim 1, wherein the radiation source and the array of detectors are stationary and the object is configured to be actuated in a translational direction relative to the radiation source and the array of detectors.

9. The system of claim 1, wherein the object is stationary and the radiation source and the array of detectors are configured to be actuated in a translational direction relative to the object.

10. The system of claim 1, wherein the array of detectors are configured to be able to detect special nuclear material or shielding material.

11. The system of claim 1, wherein the at least one radiation source comprises a gamma-ray emitting radioactive source, an x-ray source and a neutron source.

12. The system in claim 1, wherein the radiation source is a multi-energy x-ray source.

13. The system in claim 1, wherein the radiation source is a high-energy photon source and a neutron source.

14. A method for manufacturing an inspection system, comprising:
providing at least one radiation source comprising single or multiple energies, the at least one radiation source configured to transmit a radiation beam on an object comprising one or more items of interest under inspection;
providing an array of detectors configured to receive a plurality of radiation beams transmitted through the object, the array of detectors configured to be oriented at different angles with respect to the radiation beam from the at least one radiation source, and at least one of the radiation source and the array of detectors or the object is configured to be actuated in a translational direction relative to the other; and
providing processing circuitry coupled to the array of detectors and configured to generate a three dimensional image of the object.

15. The method of claim 14, further comprising providing a display monitor configured to display the three dimensional image of the object.

16. The method of claim 14, wherein said providing at least one radiation source comprises translating the at least one radiation source and the array of detectors relative to the object that is stationary.

17. The method of claim 14, wherein said providing a processing circuitry comprises a processing circuitry further configured to:
receive a plurality of radiation beams received by the array of detectors;
calculate an attenuation coefficient of one or more items of interest within the object based upon transmitted radiation beams; and
determine a plurality of parameters representing a composition and volume of the one or more items of interest based upon the attenuation coefficient.

18. The method of claim 17, wherein said providing a processing circuitry configured to determine a plurality of parameters comprises determining an atomic number, a size or a shape of the one or more items of interest.

19. The method of claim 14, wherein said providing an array of detectors comprise providing a linear array of detectors.

20. The method of claim 14, wherein said providing an array of detectors comprise providing a continuously pixilated array of detectors or an array of flat panel detectors.
